(19) United States
(12) Patent Application Publication
(10) Pub. No.: US 2004/0074215 A1
(43) Pub. Date: Apr. 22, 2004

(54) Method for making an air filter

(76) Inventor: Carlo Cocconi, Correggio (IT)

Correspondence Address: UNION CARBIDE CHEMICALS AND PLASTICDS TECHNOLOGY, CORPORATION, P.O. BOX 1967, MIDLAND, MI, 48674, US

(21) Appl. No.: 10/415,399

(22) PCT Filed: Nov. 5, 2001
(86) PCT No.: PCT/US01/47323

(30) Foreign Application Priority Data
Nov. 10, 2000 (IT) M 12000A002435

(51) Int. Cl. B01D 46/00

(52) U.S. Cl. 55/502

(57) ABSTRACT

A method for forming an air filter (1, 5) comprising a filter element (2) and at least one seal gasket (3) rigidly secured to said filter element, in which in order to form said gasket (3) a plastic material is cast in a mould (4, 8, 11), and in order to rigidly secure said filter element (2) to said gasket (3) in a sealed manner the filter element is associated with said plastic material while this is in said mould (4, 8, 11) and the curing of said plastic material is still at least partially in progress, wherein for forming each filter its own dedicated mould (4, 8, 11) is used, the mould being maintained removably associated with said gasket (3) after termination of the filter forming process.

The present invention relates to a method for forming an air filter in accordance with the precharacterising part of the main claim; the invention also relates to the filter obtained by this method and the mould for implementing the method. To form known filters, aluminium moulds are usually used presenting a first recessed seat in which plastic material is cast to form the seal gasket, and a second support seat for the filter element to which said gasket is to be secured.

These moulds are usually closed by a backing mould for impressing a desired shape on the upper part of the gasket, for preventing undesired expansion of the plastic material during its curing process, and for maintaining the filter element in a predetermined position. To accelerate the curing time of the gasket plastic material and to prevent the moulds remaining occupied for too long a time, the moulds are heated, generally within a tunnel, to accelerate the polymerization of the gasket plastic material.

The mould then has to be opened, and the filter extracted and trimmed to remove any burrs. Finally the filter has to be packaged in suitable packaging for its sale. Before they can be reused, the moulds also have to be treated with a separation agent, a complication which further lengthens the production time of known filters.

The production process for known filters is relatively lengthy and for its implementation requires means which are relatively complicated to control and use. An object of the present invention is to provide a method for producing filters in accordance with the precharacterising part of the main claim by which the operations and the necessary equipment for producing the filter are simplified.

A further object is to provide a filter forming method by which the packaging and/or wrapping operations and/or the installation of the filter are simplified. These and further objects which will be apparent to an expert of the art are attained by a filter forming method, a mould and a filter in accordance with the characterising part of the independent claims.

The present invention will be more apparent from the accompanying drawings, which are provided by way of non-limiting example and in which:

FIG. 1 is a schematic perspective view of a first embodiment of a mould according to the invention;

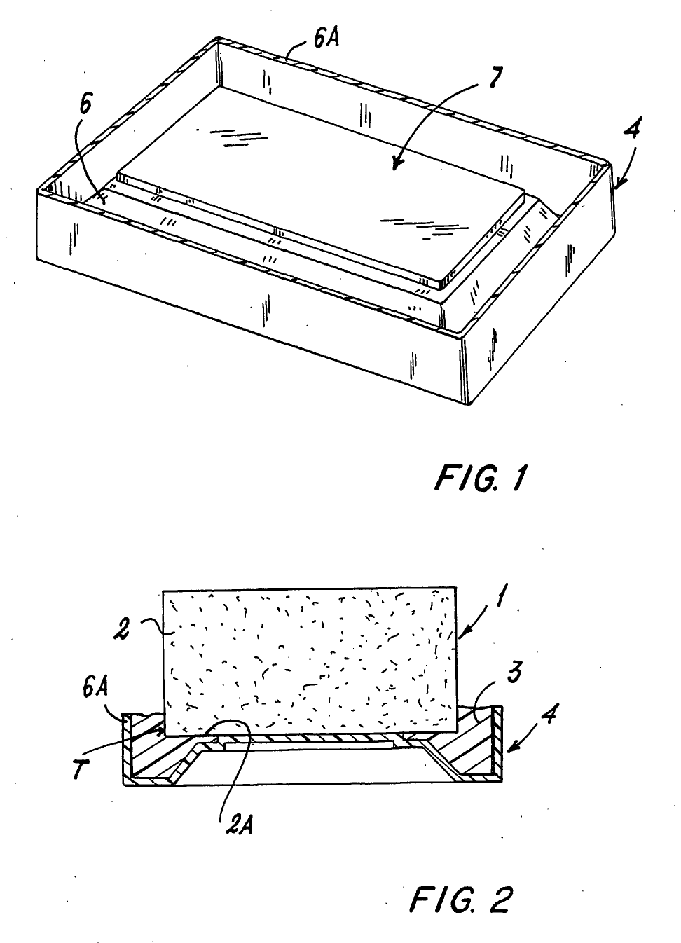

FIG. 2 is a schematic cross-section therethrough with a filter inserted;

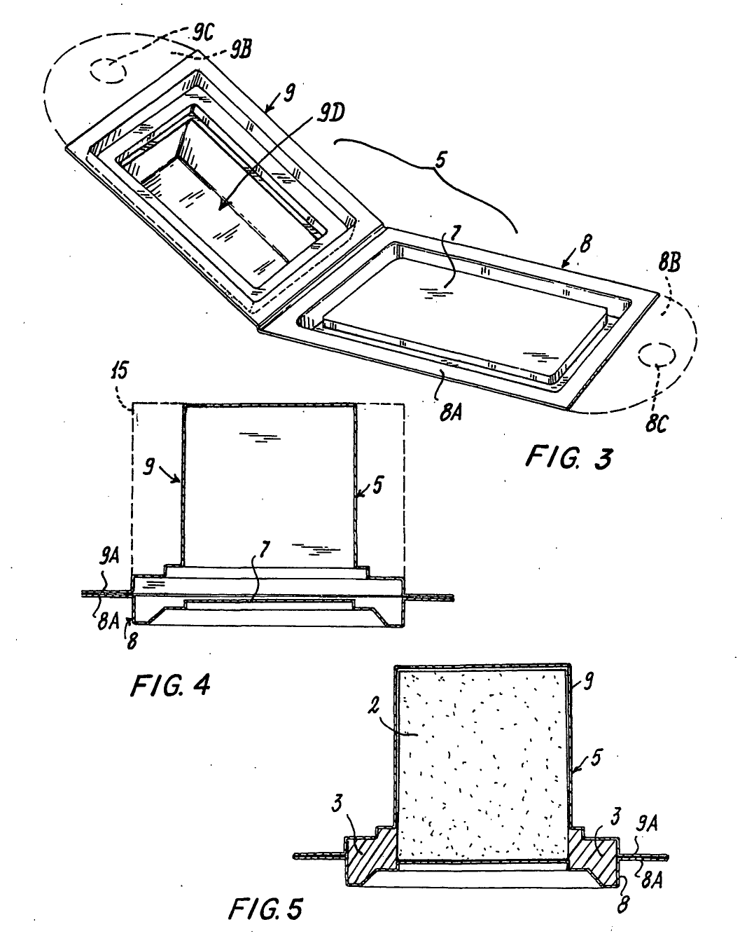

FIG. 3 is a schematic perspective view of a second embodiment of a mould according to the invention, in the open position;

FIG. 4 is a schematic cross-section therethrough in the closed position;

FIG. 5 is a schematic cross-section therethrough with a filter inserted;

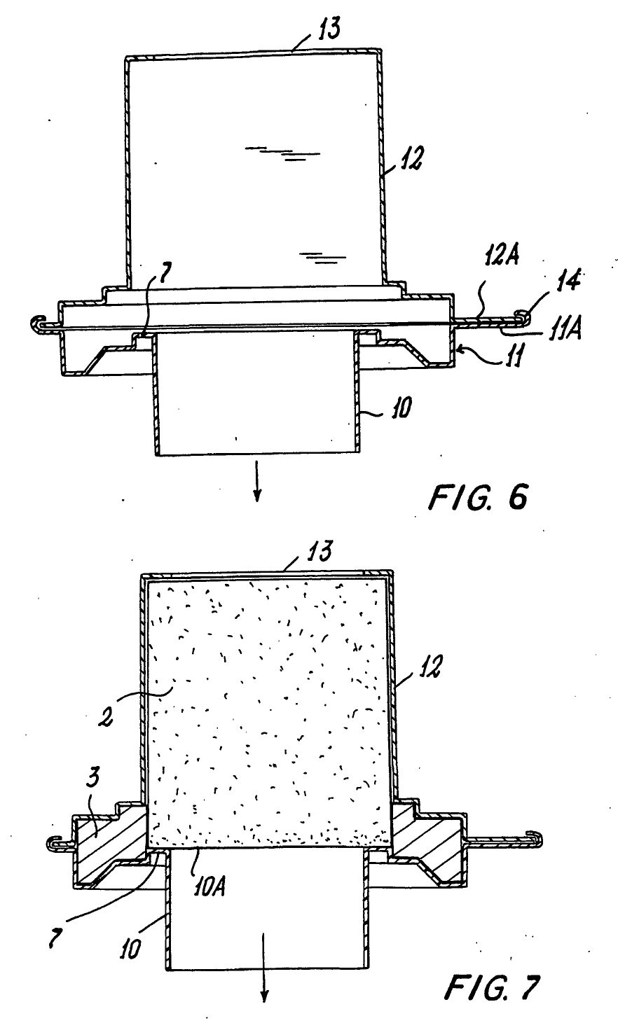

FIGS. 6 and 7 are schematic cross-sections through a further embodiment of a filter according to the invention.

To form an air filter 1 comprising a filter element 2 of usual type and a seal gasket 3 rigidly secured to said gasket element along the perimetral edge of the face 2A of said element, a plastic material is cast in a mould 4 (FIGS. 1, 2). To rigidly secure the filter element to the gasket in a sealed manner, the filter element 2 is associated with the plastic material while this is in the mould and is still only partially cured. According to the invention, to form each filter a dedicated mould 4 is used and is maintained removably associated with the gasket on termination of the filter forming process. In this respect, according to the invention the mould is advantageously constructed such as to enable each filter to use its own dedicated mould, the mould being in this manner a disposable mould (in the sense that it is not used again for a further moulding operation) which can hence finally remain associated with the filter after the filter forming process..

By virtue of the invention, the filter forming process is much simplified, in that it is not longer necessary to provide heating means for accelerating the mould plastic material curing process, neither is it necessary to trim the gasket It is also no longer necessary to transfer the moulds between the plastic material filling stations, the curing stations and the filter extraction stations, and to return the moulds to the filling station when the filters have been formed. When filled with the plastic material for the gasket and with the filter element, the moulds of the invention can be simply stored or packaged without having to force the plastic material curing process by thermal treatment.

The method of the invention can be advantageously improved by constructing the mould 5 such that it also forms the packaging for the filter; in this manner the filter production process is further accelerated by eliminating the filter packaging stage. FIGS. 1 and 2 show a first embodiment of a mould according to the invention, comprising a recessed surround 6 into which to pour the plastic material for forming the filter gasket 3, and a flat support surface 7 for the filter element 2. The flat surface 2 is provided inwards of said surround at a lower height than the free edge 6A of the recessed surround 6 and its dimensions are less than those of the face 2A of the filter element 2, so that the plastic material can surround a perimetral portion T of the element 2 at said face 2A.

The mould of the invention is formed of any material which allows easy detachment of the plastic material used to form the gasket 3 but which ensures that the shape of the mould is maintained during the infeed and curing of the gasket plastic material within the recessed surround 6.

Advantageously the plastic materials for forming the mould and the gasket are mutually incompatible, that is plastic materials having characteristics such that they cannot merge with each other during the curing of the plastic material with which the gasket is formed, and consequently extraction of the filter from the mould does not prove difficult.

The mould can for example be formed of polystyrene, polypropylene, polyethylene, teflon or mixtures of these plastic materials, or of polyethylene-clad paper. The gasket can for example be formed of a plastic polymer, preferably polyurethane. Crosslinked or non-crosslinked thermosetting polymers such as polyurethanes can for example be used. Polyurethane polymers can, for example, be used having a density variable between 0.1 Kg/l and 2 Kg/l.

FIGS. 3-5 show a variant of the already illustrated mould, in which in contrast to the already described embodiment the mould 8 in which the plastic material is cast also has a backing mould or cover 9.

The purpose of this cover is to upperly close the mould in order to limit growth of the plastic material during its curing while at the same time compelling it to assume a desired shape, so that the gasket 3 upperly presents a particular form. At the same time the cover 9 is able to maintain the filter element 2 in its correct position during the curing of the plastic material, for which purpose it presents a seat 9D shaped to house the filter element 2 as an exact fit.

The cover 9 can be constructed in one piece with the mould 8 or can be secured to it in known manner (for example by bonding or gluing or insertion-fitting) once the gasket plastic material has been poured in and the filter element positioned. Advantageously, the cover 9 and the mould 8 present flat edge faces 8A and 9A which make contact with each other when the two parts are superposed, hence facilitating the joining of the two parts. This covered mould can also be formed of the same materials described with reference to the already described mould 4.

The covered mould can also advantageously be used as the filter packaging or wrapping for its marketing. For this purpose the flat edge faces 8A, 9A can also for example comprise enlarged elements 8B, 9B and/or holes 8C/9C or other usual expedients to facilitate the fixing of the package to a display unit and/or for applying labels. If used as packaging, the mould 5 can also comprise additional outer walls 15 (shown by dashed lines in FIG. 4), to give the mould a more pleasant appearance. If used as packaging, the cover 9 and mould 8 can be rigidly secured together once the plastic material has been poured into the mould 8 and the filter element 2 has been positioned.

In a further embodiment shown in FIGS. 6, 7, the mould of the invention is shaped in such a manner as to also act as a filter holder to enable the filter to be directly associated with the device which uses the filter. In this variant, the mould 11 presents not only the characteristics described with reference to the aforegoing moulds, but also further usual elements for connecting the filter to the device which uses the filter. For example, at at least one aperture or hole 10A corresponding in position with the face 2A of the filter element 2, the mould 11 also presents a nozzle 10 to be inserted into a usual filtered air entry seat of a usual device using the filter (not shown). Likewise the cover 12 presents at least one aperture or hole 13 for passage of the air to be filtered. The cover 12 and mould 11 are associated with each other, for example by resilient clips 14 provided on the flat edge faces 11A, 12A.

By virtue of the embodiment according to this variant, the filter can be directly associated with the device requiring the filter without having to be mounted in the relative filter holder of that device.

Finally it should be noted that the aforedescribed embodiments are provided by way of example only, and that numerous variants are possible, all falling within the same inventive concept. For example, the mould and/or the cover could be provided with further seats for also forming a seal gasket along another face of the filter element 2 and/or the gasket 3 could be provided in a different position of the filter element

What is claimed is:

1. A method for forming an air filter (1, 5) comprising a filter element (2) and at least one seal gasket (3) rigidly secured to said filter element, in which in order to form said gasket (3) a plastic material is cast in a mould (4, 8, 11), and in order to rigidly secure said filter element (2) to said gasket (3) in a sealed manner the filter element is associated with said plastic material while this is in said mould (4, 8, 11) and the curing of said plastic material is still at least partially in progress, characterised by using for forming each filter its own dedicated mould (4, 8, 11) and maintaining the mould removably associated with said gasket (3) after termination of the filter forming process.

2. A method as claimed in claim 1, characterised by using the mould (8) as packaging for the filter.

3. A method as claimed in claim 1, characterised by using the mould (11) as a filter holder (11, 12) to be directly associated with the device using the filter.

4. A method as claimed in claim 1, characterised by causing the plastic material curing process to take place within the mould (4, 8, 11) without subjecting it to thermal treatment to accelerate said curing.

5. A method as claimed in claim 1, characterised by using mutually incompatible plastic materials for forming the mould (4, 8, 11) for the gasket (3), and for the gasket (3) itself.

6. A method as claimed in claim 5, characterised by using polystyrene, polypropylene, polyethylene, teflon or mixtures of these plastic materials, for forming the mould (4, 8, 11) and the gasket.

7. An air filter comprising a filter element (2) and at least one seal gasket (3) rigidly secured to said filter element (2), in which in order to form said gasket (3) a plastic material is cast in a mould (4, 8, 11), and in order to rigidly secure said filter element (2) to said gasket (3) in a sealed manner the filter element is associated with said plastic material while this is in said mould and the curing of said plastic material is still at least partially in progress, characterised in that each filter comprises its own mould (4, 8, 11), which remains removably secured to said gasket (3) on termination of curing of said plastic material.

8. A filter as claimed in claim 7, characterised in that the mould (8) is shaped such as to also act as packaging for the filter.

9. A filter as claimed in claim 7, characterised in that the mould (11) is formed in such a manner as to also act as a filter holder, to be directly associated with the device using the filter.

10. A filter as claimed in claim 7, characterised in that the mould (4, 8, 11) is formed of a plastic material incompatible with the plastic material of the gasket (3).

11. A filter as claimed in claim 7, characterised in that the mould (4, 8, 11) is of disposable type.

12. A filter as claimed in claim 7, characterised in that the mould (8, 11) comprises a cover (9, 12) arranged to maintain the filter element (2) in a desired position and/or to shape a portion of the gasket (3) in a desired manner.

13. A filter as claimed in claim 7, characterised in that the cover (9, 12) is rigidly or removably secured to the mould (8, 11).

14. A filter as claimed in claim 7, characterised in that the mould (11) comprises a recessed surround (6) into which to pour the plastic material to form the gasket (3) and, inwards of said surround, a flat support surface (3) for the filter element (2).

15. A filter as claimed in claim 14, characterised in that the flat support surface (7) is provided at a lower height than the free edge (6A) of the recessed surround (6) and has smaller dimensions than that face (2A) of the filter element (2) which rests on said surface (7).

16. A mould for forming an air filter (1, 5) comprising a filter element (2) and at least one seal gasket (3) rigidly secured to said filter element, in which in order to form said gasket (3) a plastic material is cast in the mould, and in order to rigidly secure said filter element (2) to said gasket (3) in a sealed manner the filter element is associated with said plastic material while this is in said mould, characterised by being shaped in such a manner as to form an accessory element (4) of the filter in order to be able to remain removably associated with the filter even after termination of curing of said plastic material.

17. A mould for forming an air filter (1, 5) comprising a filter element (2) and at least one seal gasket (3) rigidly secured to said filter element, in which in order to form said gasket (3) a plastic material is cast in the mould, and in order to rigidly secure said filter element (2) to said gasket (3) in a sealed manner the filter element is associated with said plastic material while this is in said mould, characterised by being shaped in such a manner as to be able to be also used as at least a part of the packaging (8) of the filter.

18. A mould for forming an air filter (1, 5) comprising a filter element (2) and at least one seal gasket (3) rigidly secured to said filter element, in which in order to form said gasket (3) a plastic material is cast in the mould, and in order to rigidly secure said filter element (2) to said gasket (3) in a sealed manner the filter element is associated with said plastic material while this is in said mould, characterised by being shaped in such a manner as to be able to be also used as a filter holder (11) to be directly associated with the device using the filter.

19. Packaging for an air filter of the type comprising a filter element (2) and at least one seal gasket rigidly secured to said filter element, in which in order to form said gasket (3) a plastic material is cast in a mould (8), and in order to rigidly secure said filter element (2) to said gasket (3) in a sealed manner the filter element is associated with said plastic material while this is in said mould; characterised in that said mould (8) is shaped in such a manner as to be able to be also used as at least a part of the packaging for the filter.
